(19) United States
(12) Patent Application Publication
(10) Pub. No.: US 2008/0280257 A1
(43) Pub. Date: Nov. 13, 2008

(54) System and method to provide occlusal alignment in restorations

(76) Inventor: Kenneth Guthrie, Ocala, FL (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(21) Appl. No.: 12/151,862

(22) Filed: May 9, 2008

Related U.S. Application Data
(60) Provisional application No. 60/928,478, filed on May 9, 2007.

(51) Int. Cl. A61C 13/093

(52) U.S. Cl. 433/197

(57) ABSTRACT

The generation of restorations is easily and effectively achieved by utilizing specific functional considerations that account for typical movement of a patient's mouth. With these movements in mind, the initial starting point for restoration design is the identification of functional occlusal cusps (FOCs) and centric landing pads (CLPs). Based upon the identification and anticipation of these structures, restoration can be designed which will be effectively avoid any interference or undesired interaction between teeth (either existing or restoration). The process of restoration design further considers and designs escape routes for use in configuring the restoration. These escape routes identify those areas anticipated to be occupied by cusps or other components of existing teeth, during natural functional or movement. Consequently, the identification of escape routes helps to place grooves or tracks within the restoration, thus naturally providing clearance. Based upon the consideration of these elements, the resulting restoration is efficient and effective without requiring considerable adjustment by the dentist at the time of fitting.

### RELATED APPLICATIONS

This application is related to Provisional Application Ser. No. 60/928,478, filed on May 9, 2007, entitled “System and Method to Provide Occlusal Alignment in Restorations”, and which is relied upon for priority and incorporated herein in its entirety.

### BACKGROUND OF THE INVENTION

The present invention relates to the restoration of teeth. More specifically, the present invention relates to the creation of teeth restoration while considering functional aspects, thus providing alignment and shape characteristics to provide functional harmony for a user.

Replacement teeth and dentures have been created and manufactured for many years. Naturally, it is a desire to reproduce or reconstruct teeth in a manner so they are the most efficient and useable by the users themselves. In addition, the cosmetic features and characteristics of the teeth themselves should also be considered to produce a result which is attractive and realistic.

Previous reconstructions have focused primary on cosmetic nature of the finished teeth or dentures. This is also true with applications primarily involving occlusal table design. The functional aspect is also concern, to ensure that the reconstructed teeth can be efficient and pain-free during use. Unfortunately, the functioning aspect of mastication of the finished product is sometimes overlooked by the design. Consequently, the resulting denture, crown & bridge and/or commendations of restoration and other types of appliances may include inherent problems. These issues often become most evident at points of contact, where interference between upper and lower teeth creates issues during natural movements. This requires the dentist to make significant adjustments and modifications during the fitting process, which is often imprecise and tedious.

### BRIEF SUMMARY OF THE INVENTION

In order to provide a functionally effective restoration during mastication, the present invention provides a method which specifically considers function in mastication and speaking in the occlusal table design to provide a more efficient result. The method of the present invention recognizes the functional aspects of occlusal table design and specifically considers those aspects during the design of the dentures or teeth and/or commendations of restoration appliance. The models or teeth created utilizing the process and system are consequently better suited for use, thus requiring fewer adjustments during the fitting process.

The present invention begins by recognizing that at least one functional occlusal cusp (FOC) exists on each of the upper and lower posterior teeth. The functional occlusal cusps are the prominent cusp of each tooth which produces the maximum chewing efficiency. Further, FOC's are the lingual cusp of the upper posterior and the buckle cusp of the lower posterior teeth. In the method of the present invention, the goal is to design and configure these functional occlusal cusps so as to avoid interference and strain with opposing surfaces.

In addition to the functional occlusal cusps, the present invention also recognizes corresponding centric landing pads (CLP) (or centric stops) which provides mating surfaces for each functional occlusal cusp. In each case, an ideal location for each functional occlusal cusp and centric landing pad exists, which provides initial starting point for the restoration. By recognizing these components and surfaces of the teeth, the present invention can consider the functional occlusal table design of the subsequent reconstruction, and appropriately configure these prominent components to avoid interference.

In the ideal reconstruction, the functional occlusal cusp and centric landing pads are aligned with one another to define an isolated stop and avoid any interference during function. At the same time these elements are configured so that the driving forces created are at a 90 degree angle down the root of the adjacent teeth, thus giving a stable stop in centric occlusion and intercuspation.

In the method of the present invention, the designer or tooth fabricator further specifically considers the size of the tip of the FOC. This is critical in managing the amount of force generated down the long axis of the tooth. In addition, the designer similarly considers the size of the corresponding CLP so that the FOC can avoid interference in function and/or in centric occlusion.

In addition to the above referenced recognition of the components, the present invention also takes into consideration several other natural occurring relationships for teeth. This can be measured precisely by the functional movement of the patient during mastication. Additionally, method of the present invention considers the height of the FOC as compared to the nonfunctioning cusp on a horizontal plane.

The method of the present invention further considers “escape routes” when designing restoration teeth. These escape routes are generally the paths of typical cusp motion during functional movement in a horizontal plane. The consideration of these escape routes is critical when designing the occlusal table so as to avoid interference. Additionally, the system and method of the present invention considers the “eve affect,” which allows immediate freedom without interference from centric occlusion. This also allows easy verification that interference has been avoided.

In addition to the above referenced recognition of components and their use in the configuration of the restoration, the present invention also takes into consideration several other natural occurring relationships for teeth. For example, the curve of Spee may be considered, which is the anatomical curve established by the occlusal alignment of the teeth as projected onto the medial plane, beginning with the cusp tip of the mandibular canine and following the buckle cusp tips of the premolar and molar teeth continuing through the anterior border of the mandibular ramus, and ending with the anterior most portion of the mandibular condyle. Additionally, an angle of eminence may be considered which includes the angle at which the motion of the mandible moves during speaking and anterior mediolateral movements. Further, the curve of Wilson can be incorporated into full mouth restorations. This specifically considers the mediolateral curve suggesting occlusion should be spherical. The curator of the cusp as projected on a frontal plane expressed in both arches; curve in the lower art being concave in the one in the upper art being convex. This curve of Wilson provides a appropriate angle of tilt for the posterior teeth, typically in a range of a 8-12%. This can be measured precisely by the functional movement of the patient during mastication. Based upon this measurement, and other pieces of data provided about the patent, the above curves and angles can be calculated, and potentially utilized during certain restoration activities.

### BRIEF SUMMARY OF THE DRAWINGS

Further objects and advantages of the present invention can be seen from the following description below, in conjunction with the drawings, in which the steps of the above-referenced processes are shown. More specifically, various aspects and views of the invention are shown in the following drawings, including:

FIG. 1 generally illustrates two opposing exemplary teeth;

FIG. 2 shows ideal positions for the Functional Occlusal Cusps and Centric Landing Pads on the maxillary teeth;

FIG. 3 shows the ideal positions for the Functional Occlusal Cusps and Centric Landing Pads of the mandibular teeth;

FIGS. 4 and 5 generally illustrate the size of the tip having a radius of approximately 1 mm on a flat surface on a Functional Occlusal Cusp;

FIGS. 6 and 7 generally illustrate the size of the Centric Landing Pads having a radius of approximately 1½ mm on a flat surface on a tooth;

FIGS. 8 and 9 illustrate the concept of escape routes as corresponding with the paths of motion during functional movement;

FIGS. 10 and 11 generally illustrate the concept of the eve affect which allows immediate freedom without interference;

FIG. 12 shows an exemplary restoration in a holding device;

FIGS. 13-19 show different stages of tooth developing using the present process.

FIG. 20 shows the completed upper nonfunctional cusps as aligned with the opposing tooth with the eve affect;

FIG. 21 illustrates the completion of the occlusal table of the posterior teeth.

### DESCRIPTION OF THE INVENTION

As mentioned above, the present invention considers the Functional Occlusal Cusp (FOC) and Centric Landing Pads (CLP) for the teeth during the process of restoration. Functional Occlusal Cusp harmony is important for opposing teeth to ensure all functional ranges and movements will be possible to provide masticatory efficiency without causing undue stress to related tissues. These prominent cusps on the masticating surfaces are designed to articulate with the teeth that oppose these prominent cusps. Functional occlusal cusps (FOC) are the lingual cusps of the upper posterior and the buccal cusp of the lower posterior teeth. The use of FOC's as one basis for the restoration tooth design provides resulting efficiency when actually used by a patient.

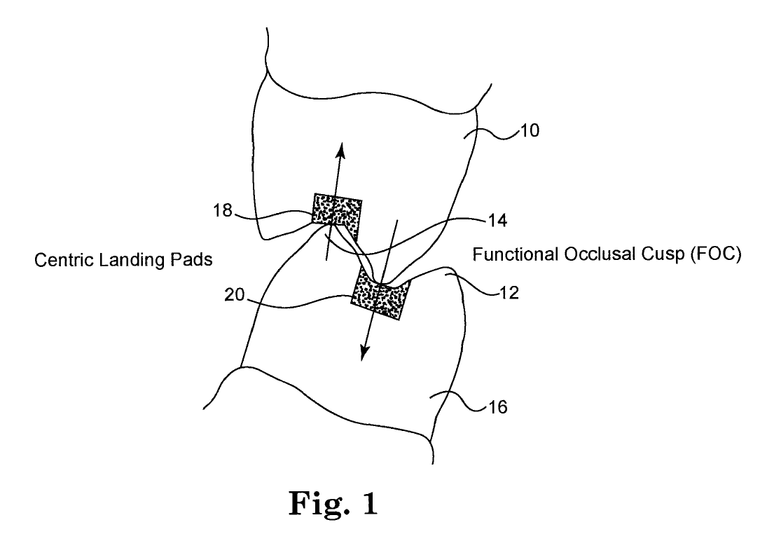

For further reference, upper FOC 12 of upper posterior tooth 10 is illustrated in FIG. 1. Similarly, lower FOC 14 of lower posterior tooth 16 is also illustrated in FIG. 1. In addition, the cooperating centric landing pads are also illustrated in FIG. 1. Centric landing pads or centric stops oppose the cusp of a related tooth and their initial identification is an important step. More specifically, this centric landing pad is the flat surface (pad) into which a related FOC interacts during occlusion. FIG. 1 illustrates centric landing pad 18 of upper posterior tooth 10, and centric landing pad 20 of lower posterior tooth 16. In this relationship, centric landing pads have a diameter of approximately 1.5 millimeters at the end of a prominent cusp curvature. Similarly, the FOC's are typically flat at the tip and have a related diameter of approximately 1 millimeter. As will be further discussed below, starting a restoration by appropriately coordinating and positioning these components provides for a more efficient and effective restoration design process. Individually, these concepts are understood by definition, but the comprehensive use of these characteristics in mastication function and in speech provides for more efficient model. Lastly, FIG. 1 also illustrates the concept of forces driving down the long axis of the tooth, using functional occlusal cusps and centric lending pads.

The process of the present invention which considers both functioning and nonfunctioning cusp, is a new concept as generally shown in the various figures. Further, the projection of the escape routes is a new concept, enabled by new technology that can read the movement of the mandible. The functional movement of mastication and speaking is specifically considered, which the dental community has not been utilizing during prior restoration activities. Additionally, using the eve affect as a guide for a clearance, so that the designer can see that there is no interference in centric occlusion, provides further advantages. The concept of being able to know in centric occlusion that there is absolutely no hitting on any inclined areas, with flat stops both on the FOC and the CLP provides great advantages not presently being considered.

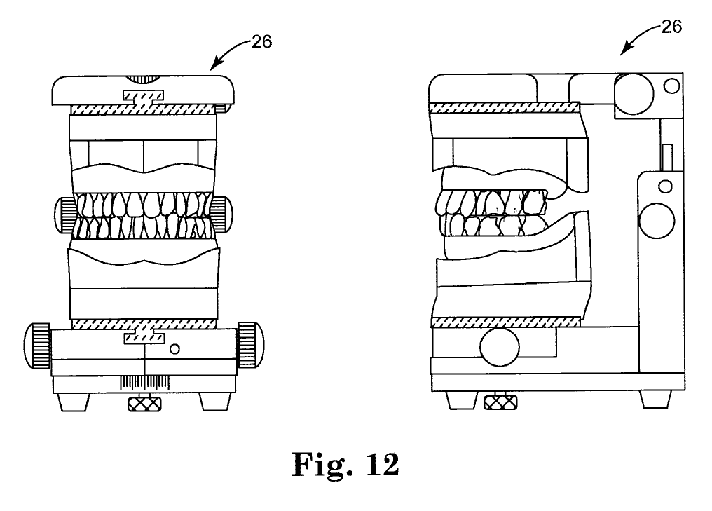

The process of the present invention provides the steps necessary to appropriately produce the reconstruction generally outlined above. Generally speaking, the process begins by mounting of an upper maxillary model on a simulator or holding device 26, which provides for holding and alignment of the model during creation. This step is generally shown in FIG. 12 wherein a full mouth reconstruction is mounted. One such holding device 26 is the AccuLiner, produced by AccuLiner products of Bellevue, Wash. Similarly, a lower mandibular model is attached to the holding device. It will be understood that partial reconstructions or single teeth could also be placed on such a holding device.

The process of creating the restoration begins by creating a wax model of the tooth or teeth to be created in a matter to ensure they are approximately aligned position using the alignment device 26. This tooth, or these teeth can be aligned to be in a desire plane by utilizing a reference table on the mounting device. This process continues until the tooth or teeth are formed in wax models, each appropriately aligned. As the tooth or teeth typically will overlap with the other teeth, alignment considers are not yet necessary, but will be incorporated.

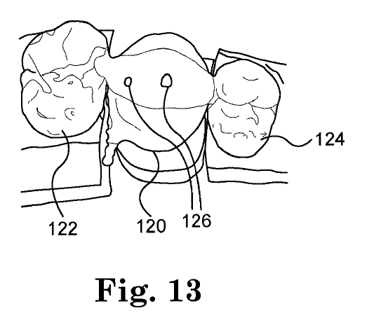

To generally illustrate the process of the present invention, an upper posterior molar 120 was selected to as an example tooth to be created. It will be understood that this is simply one example embodiment, and the same process could clearly be carried out with any upper or lower posterior tooth. For reference, FIGS. 13-21 illustrate upper posterior molar 120 adjacent to surrounding teeth 122 and 124.

In larger cases that involve the process of creating both the upper posterior teeth against the lower posterior teeth, the same process is utilized to create each tooth. As a starting point, the FOCs are the first to be designated with a circular area having a diameter of approximately 1 mm at the tip of the cusp. Similarly, CLPs are also designated with the intended diameter of each CLP being approximately 1½ mm.

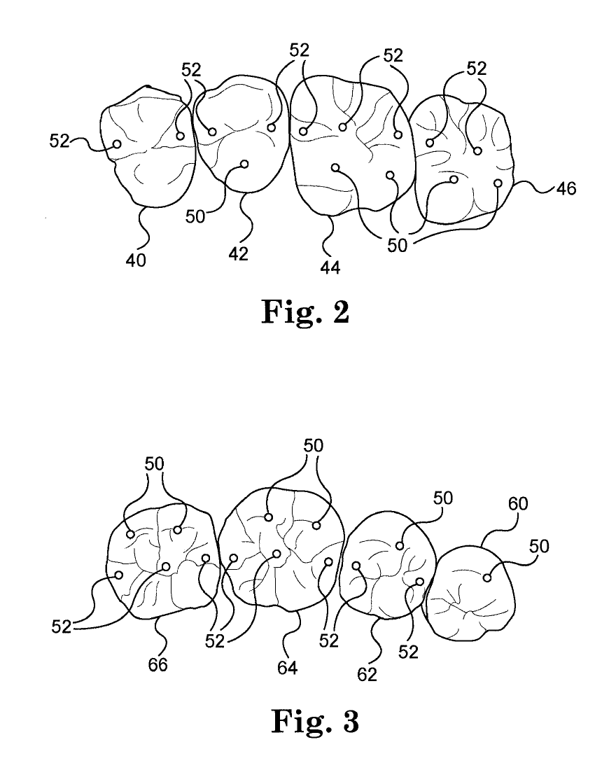

Referring now to FIGS. 2 and 3, the general identification of functional occlusal cusps (FOS) and centric landing pads (CLP) is further described. Starting with FIG. 2, the maxillary teeth of the occlusal table are illustrated. Generally speaking, FIG. 2 illustrates a first maxillary tooth 40, a second maxillary tooth 42, a third maxillary tooth 44, and a fourth maxillary tooth 46. Upon each of these teeth, the intended FOC 50 (or FOC's 50) is identified along with the intended CLP 52 (or CLP's). As generally discussed with relation to FIG. 1, these components of each tooth provide a central design consideration for creating restorations.

Similarly, FIG. 3 illustrates four mandibular teeth making up the occlusal table. Specifically, a first mandibular tooth 60, a second mandibular tooth 62, a third mandibular tooth 64, and a fourth mandibular tooth 66 are illustrated. Again, the intended FOCs 50 and CLPs 52 on each respective tooth are identified. As can be seen, FIGS. 2 and 3 illustrate the preferred locations for each component on each of these respective teeth. Using this information, all of these teeth, or any single one of them, could easily be created utilizing the concepts of the present invention.

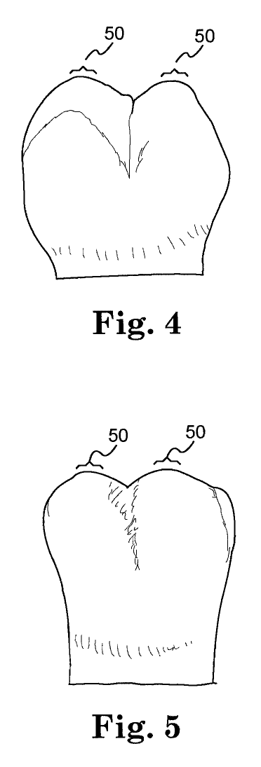

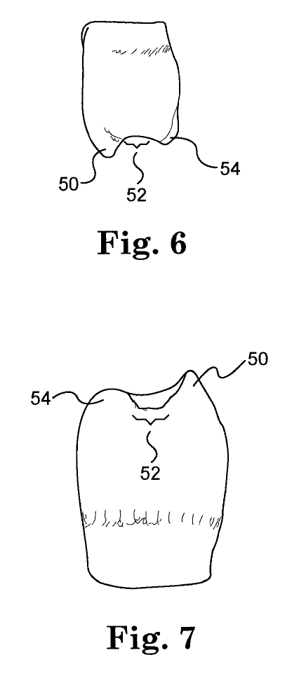

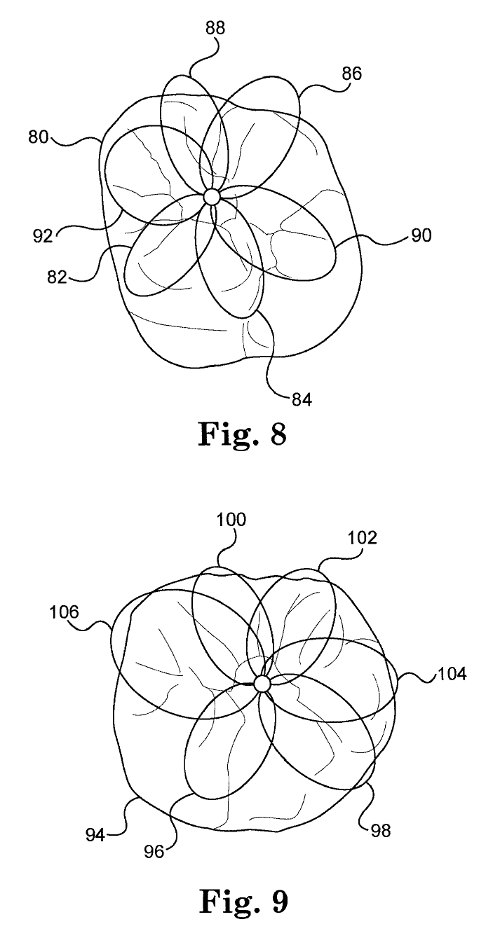

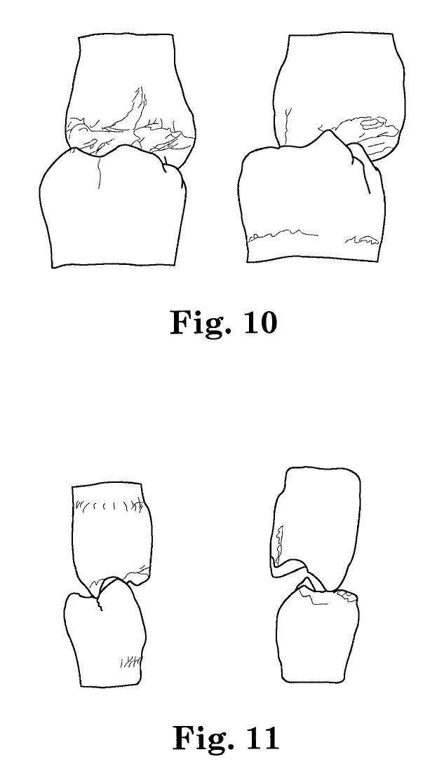

FIGS. 4 and 5 illustrate the FOCs from side and perspective views. More specifically, these FOCs 50 are flat portions at the tip of the cusps, which generally have a chosen diameter of approximately 1 mm. Similarly, FIGS. 6 and 7 illustrate CLPs 52 in a side and perspective view. The CLP 52 are designated as relatively flat pads at a lower portion of the tooth, which has an identified diameter of approximately 1½ mm. FIGS. 6 and 7 also illustrate non-functioning cusps 54. These features must also be created during the development of a restoration tooth, but are considered later in the process. Further, FIGS. 6 and 7 illustrate the height of FOC 50, which is also to be considered.

As mentioned above, the design and configuration of restoration teeth involves the consideration of escape routes, in addition to various other considerations. Generally speaking, escape routes anticipate the functional movement of teeth, and establish zones or areas where clearance must exist to avoid interference. The escape routes are based upon FOC height and anticipated movements. Referring now to FIG. 8, various escape routes are illustrated relative to an example upper first molar 80. As generally discussed above, escape routes anticipate the functional movement of the teeth and appropriately avoid interference during this movement. More specifically, FIG. 8 illustrates the protrusive, medio-lateral and functional movement on a horizontal plane. The various escape routes illustrated are based on several anticipated movements for the teeth, as related to adjoining or cooperating teeth. Initially, a first escape route 82 is established for functional movements, while a second escape route 84 is established to anticipate protrusive mediolateral movement. Generally speaking, the position of the distal buccal groove on the upper posterior is designed as an escape route to deal with these particular movements. Similarly, a third escape route 86 and a fourth escape route 88 are established to deal with functional movement and protrusive medio-lateral movement caused by condylar movement of the teeth. Lastly, a fifth escape route 90 and a sixth escape route 92 are utilized to react to sagittal functional movement and antero-posterior movement, respectively. Utilizing these escape routes, grooves on the posterior wall of the fassa and distal groove can all be designed and positioned to avoid related interference.

Referring now to FIG. 9, similar escape routes are established for the lower first molar 94. More specifically, a first escape route 96 and a second escape route 98 anticipate the functional and protrusive medio-lateral movement for the first lower molar 94. Similarly, third escape route 100 and fourth escape route 102 help identify the positioning of the lingual grooves related to the posterior wall of the fassa and which help address condylar movement. Lastly, antero-posterior movement and functional movement are considered when establishing a fifth escape route 104 and sixth escape route 106. Once each of these escape routes are established, further functional design of the restoration can be achieved.

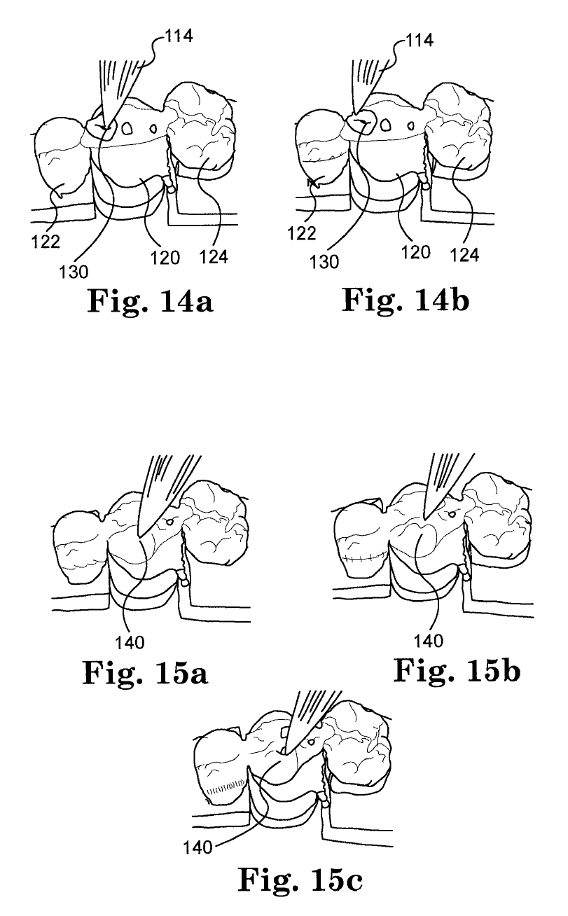

In FIGS. 13-21 various stages of tooth formation for tooth 120 are illustrated. These figures illustrate working tool 114 generating these structures. Referring specifically to FIG. 13, on the upper posterior tooth 120, a CLP will be approximately located somewhere in the center of the tooth so the driving forces are down the long axis of the tooth. This partially design places CLP 126 in the appropriate position, using the opposing mode. CLP 126 can be further defined/isolated by using pits and grooves 130, as shown in FIG. 14. Again, the centric landings pad 126 must align with the FOC of the lower adjacent posterior tooth (or if it is the lower tooth that is being designed, then the CLP must align with the FOC of the upper adjacent tooth).

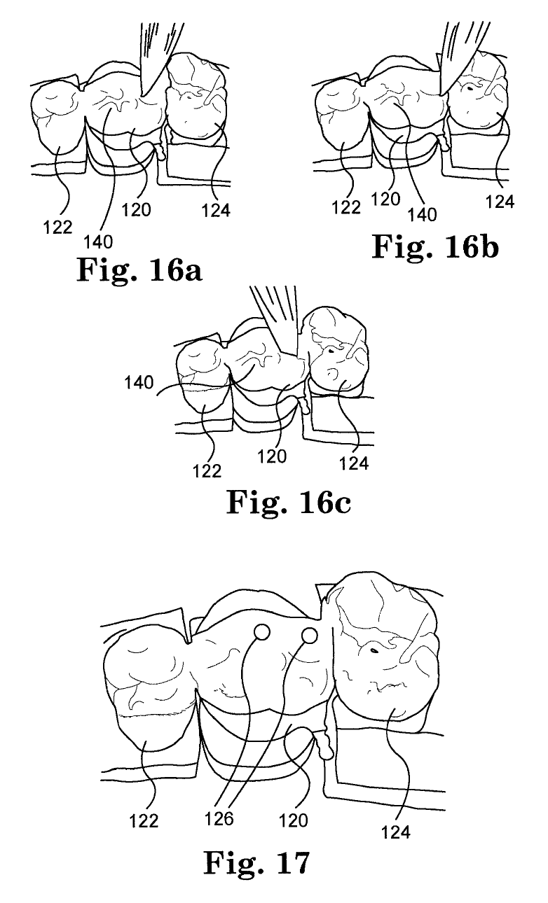

Next, specific consideration of the FOC 140 must now be made. Specifically, the formation an alignment of the FOC 140 against the opposing model is necessary. Using escape routes to strategically define and isolate, the top of the FOC 140 is designed. Again this will involve design the lingual functional occlusal cusp of the upper posterior teeth at this point in time. Additional FOCs 142 (if present) must also be incorporated. As generally shown in FIGS. 15 and 16, the tooth begins to take further form based upon these designed structures.

Using the above-mentioned concepts, an outline of the upper tooth 120 can be generally created which does provide a good starting point for this portion of the restoration. Again in this manner the FOC and CLP for the upper posterior tooth 120 can be formed. For example, FIG. 17 illustrates the more specific desired placement of CLP's 126.

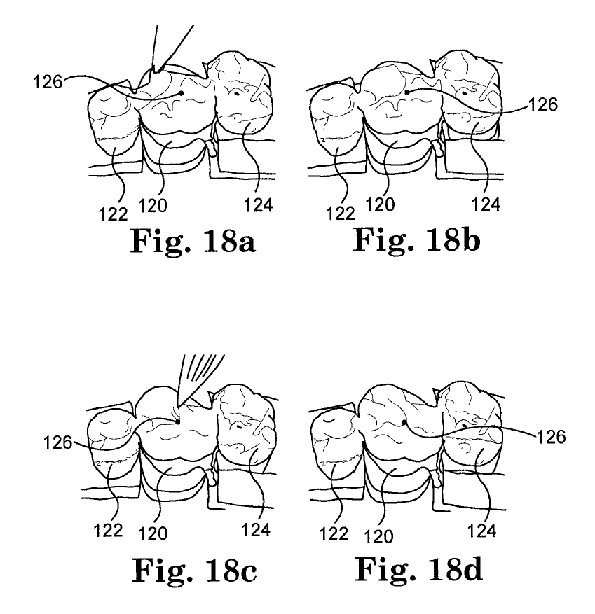

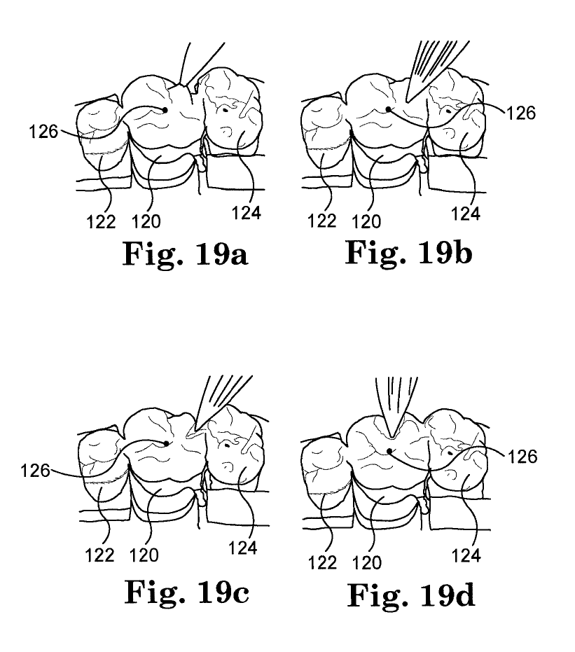

Moving on now to the nonfunctioning cusp 146 we now start designing these cusp by moving away from the CLP 126 while utilizing the previously established escape routes. This will provide the advantage of movement for function in mastication so there is no interference going out a centric occlusion. FIGS. 18 and 19 illustrate these steps.

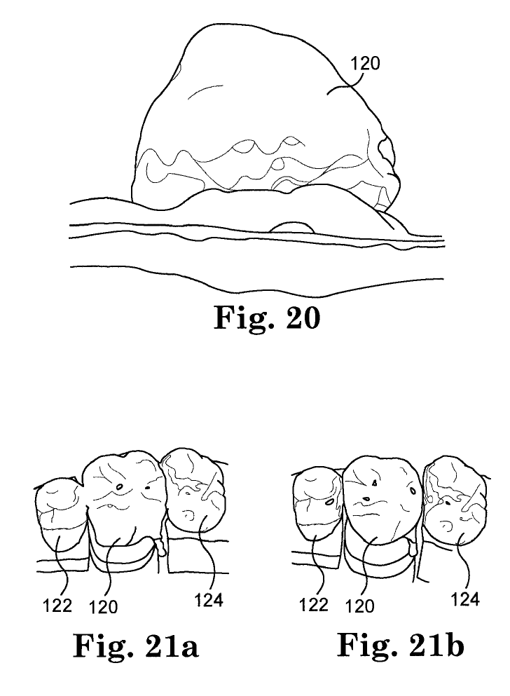

Once the tooth has been completely designed, closure can be evaluated. Using the holding device, capable of holding of the primary upper and lower models or approximations of each, alignment in full closure can be easily evaluated. This allows for the easy evaluation of alignment and positioning, as shown in FIG. 20. Further consideration of interference in the eve affect his made by examining the overall configuration of the posterior tooth. To carry out this check, the designer will look for the functional occlusal cusp hitting the centric landings pad, without hitting any incline of the cusp.

Again, the CLP is an area of approximately 1½ mm corresponding to an FOC, having the size of approximately 1 mm in diameter. This is more easily achieved due to the fact that the inventor understands function in mastication and speaking. As seen necessary, minor adjustments can easily be made to the CLP at this point. Similarly, FOC can be adjusted. Finally the tooth is completed as shown in FIG. 21.

As suggested above, the consideration of FOC's and CLP's will allow for partial or full mouth restoration as needed. In these cases, each tooth will similarly be designed. For example, a restoration may begin at the first posterior bicuspid, as generally outlined above. Once the second bicuspid is reached, similar consideration of the FOC must be made. Again, the FOC is defined to be a circular area with the diameter of approximately 1 mm in each case. On the upper posterior teeth this will be the lingual cusp of the second bicuspid through the lingual cusp of the third molar. A specialized alignment plate could be used on the positioning device which takes into consideration the curve of Spee of the upper FOC's. This partial design places the FOC's for these teeth in the appropriate position, using the above referenced alignment template, or opposing alignment device as shown in FIG. 12. Using the alignment plate the functional occlusal cusp of the second Bicuspid and first molar and second molar and a third molar may be appropriately designed, each utilizing this alignment plate and appropriately positioned. Again this will involve design of the lingual functional occlusal cusp of the upper posterior teeth at this point in time. In this manner teeth of the FOC for any or all the posterior teeth can be formed.

In several restoration cases, specific consideration of the lower teeth must be made after the upper teeth are formed. Specifically, the formation and alignment of the FOC's with the related CLP is necessary.

Using the above-mentioned alignment plate, an outline of the lower teeth can be generally created, which provides a good starting point for this portion of the restoration. Again, the formation of models of the lower posterior teeth is made possible by utilizing the above-mentioned alignment plate to aid in obtaining approximately alignment for the curve of Spee on the lower posterior teeth.

The model now takes into consideration the CLP, for the lower teeth. Specifically the holding device, now capable of holding of the primary upper and lower models, can position the teeth to simulate occlusion. In this position, adjustments can be made to appropriately design CLP's, starting with the upper posterior teeth. The CLP's are areas corresponding to each of FOC's, each having the size of approximately 1.5 mm in diameter. This is more easily achieved due to the fact that only a portion of the upper posterior teeth has been created at this point. As necessary, adjustments can easily be made to the upper CLP's at this point. Similarly, CLP's for the lower posterior teeth can now be created. Again, these are areas of approximately 1.5 mm in diameter corresponding to the FOC's of the upper posterior teeth.

Next, the non-functioning cusp of the upper posterior teeth may now be formed. These non-functioning cusp also are adjacent to the centric landings pads of the upper posterior teeth and form the remaining portion of these teeth. Again, the centric landings pads must align with the functional occlusal cusp of the lower posterior teeth.

Escape routes can be made by examining the overall configuration of each tooth. Similarly, any portion of the lower posterior teeth can be created with consideration of interference and escape routes can be made by examining the overall configuration of each tooth. The lower becomes a mirror configuration of the upper posterior teeth.

Once all the upper and lower posteriors are created one last check alignment and positioning can easily be achieved. Further consideration of interference in the roof effect/eve affect his made by examining the overall configuration of the posterior teeth. Look for the functional occlusal cusp heading the centric landings pads, without hitting any incline of the cusp.

As outlined above, it is an object of the present invention to provide a method which easily and efficiently creates a single to a full mouth reconstruction, and dentures which considers functional occlusal concerns. Using all appropriate considerations, the resulting restorations will be functionally efficient, and require very few adjustments.

What is claimed is:

1. A method for the creation of dental tooth restorations which consider functional aspects of anticipated occlusion thus minimizing needed adjustments when placed in a patient's mouth, comprising:
identifying positions for at least one centric landing pad on a restoration tooth to be created and forming an initial portion of the upper surface of the tooth to establish the identified centric landing pad;
locating escape routes necessary for the restoration tooth, wherein the escape routes identify areas above the restoration tooth that must be free of structure so as to avoid interference with any surrounding teeth during functional occlusion;
identifying positions for at least one functional occlusal cusp on an upper surface of the restoration tooth wherein the functional occlusal cusp provides further tooth structure capable of interacting with a centric landing pad for a corresponding tooth, the functional occlusal cusp being situated in areas away from the escape routes;
forming the at least one functional occlusal cusp at the identified position; and
forming the remaining restoration tooth structure based to cooperate with the previously formed functional occlusal cusps and the centric landing pads.

2. The method of claim 1 wherein the restoration tooth includes multiple centric landing pads and multiple functional occlusal cusps.
